(19) United States
(12) Patent Application Publication
(10) Pub. No.: US 2022/0188852 A1
(43) Pub. Date: Jun. 16, 2022

(54) OPTIMAL PRICING ITERATION VIA SUB-COMPONENT ANALYSIS

(71) Applicant: International Business Machines Corporation, Armonk, NY (US)

(72) Inventors: Indervir Singh Banipal, Austin, TX (US); Shikhar Kwatra, San Jose, CA (US); Nadiya Kochura, Bolton, MA (US); Sourav Mazumder, Contra Costa, CA (US)

(21) Appl. No.: 17/117,175

(22) Filed: Dec. 10, 2020

(51) Int. Cl. G06Q 30/02; G06N 20/20

(52) U.S. Cl. CPC G06Q 30/0206; G06N 20/20; G06Q 30/0201

(57) ABSTRACT

In an approach for determining an optimal price for a product via a sub-component analysis, a processor determines a similarity weightage for each similar product to a product based on specifications and ratings for each similar product. A processor determines a price for each subcomponent of the product based on a base price of the respective subcomponent, a cost for work required to integrate the respective subcomponent into the product, and intellectual property and licensing costs associated with the respective subcomponent. A processor calculates a price prediction for the product by summing up the price for each subcomponent. A processor determines an optimized price prediction for the product based on integrating the similarity weightage for each similar product with the price prediction for the product in an ensemble model.

### BACKGROUND OF THE INVENTION

The present invention relates generally to the field of retail pricing, and more particularly to an optimal pricing iteration via sub-component analysis.

For retailers, establishing retail pricing objectives is a critical first step toward determining the optimal retail pricing for their retail goods. It is important to think about not just financial goals, but strategic and marketing goals as well. Also, considering how customer expectations play a role in the pricing objectives is helpful. A common strategy is to lure customers away from the competition by offering matching or lower prices. Pricing involves a little bit of art, a little bit of science, and a whole lot of strategy—including balancing the prices across an entire product range to achieve your goals.

A manufacturer's suggested retail price (MSRP) begins with the manufacturer setting a product price that incorporates data regarding the pricing of similar products, the cost to manufacture the product, and a profit margin for both the manufacturer and the retailer. Then, the manufacturer offers the retailer, that product at a wholesale price, traditionally half the MSRP. This type of pricing is typically referred to as cost-based pricing or cost-plus pricing since most of the price is based on the cost to produce and sell the item. The “plus” component refers to the margin that's created when the manufacturer adds a markup to the wholesale price.

A few other types of pricing include keystone pricing, bundle pricing, discount or promotional pricing, loss-leading pricing, below competition pricing, above competition pricing, and anchor pricing. There is probably no single pricing strategy that will work for all of a retailer's products, so retailers may employ a concept called intelligent pricing. Intelligent pricing strategies leverage market data to optimize prices, updating as the market changes to remain competitive.

### SUMMARY

Aspects of an embodiment of the present invention disclose a method, computer program product, and computer system for an optimal pricing prediction iteration via sub-component analysis. A processor determines a similarity weightage for each similar product to a product based on specifications and ratings for each similar product. A processor determines a price for each subcomponent of the product based on a base price of the respective subcomponent, a cost for work required to integrate the respective subcomponent into the product, and intellectual property and licensing costs associated with the respective subcomponent. A processor calculates a price prediction for the product by summing up the price for each subcomponent. A processor determines an optimized price prediction for the product based on integrating the similarity weightage for each similar product with the price prediction for the product in an ensemble model.

In some aspects of an embodiment of the present invention, a processor dynamically determines an optimal price prediction for the product by augmenting the optimized price prediction for the product with shopper experience analytics in a reinforcement learning model.

In some aspects of an embodiment of the present invention, responsive to a user through the user device requesting the optimal price prediction for the product, a processor determines the similarity weightage for each similar product to the product based on specifications and ratings for each similar product.

In some aspects of an embodiment of the present invention, a processor compares product features from the specifications and the ratings for each similar product to the product.

In some aspects of an embodiment of the present invention, a processor receives a list of products from a user through a user device, wherein the product is in the list of products.

In some aspects of an embodiment of the present invention, a processor outputs the optimal price prediction for the product to the user device.

In some aspects of an embodiment of the present invention, the shopper experience analytics include rejections of an offer for the product by a shopper at the optimized price prediction.

### BRIEF DESCRIPTION OF THE DRAWINGS

FIG. 1 is a functional block diagram illustrating a distributed data processing environment, in accordance with an embodiment of the present invention.

FIG. 2 is a flowchart depicting operational steps of a setup component of an optimal pricing program, in accordance with an embodiment of the present invention.

FIG. 3 is a flowchart depicting operational steps of the optimal pricing program, for determining an optimal price for a product via a similarity weightage determination to similar products and a sub-component analysis, in accordance with an embodiment of the present invention.

FIG. 4 depicts a block diagram of components of a computing device of the distributed data processing environment of FIG. 1, in accordance with an embodiment of the present invention.

### DETAILED DESCRIPTION

Embodiments of the present invention recognize that, in the online retail industry, retailers often need to arrive at daily online prices for their products after comparing prices for the same or similar products on a competitor's website. However, a majority of the time, the products cannot be directly compared because of slight differences in specifications, number of units, value added services, etc. Hence, instead of directly using the pricing of a similar product, retailers need some way to apply some sort of similarity weightage that goes into a pricing model for pricing their product. Obtaining this similarity weightage using a deterministic way of using rules can be challenging, therefore, embodiments of the present invention employ machine-learning and data science in obtaining a similarity weightage between a competitor's product and the retailer's product.

Embodiments of the present invention provide a program for optimal pricing prediction based on visual and textual correlation and comparison of sub-components. Embodiments of the present invention utilize a hybrid prediction model with a rule-based module to determine a similarity weightage between two products and machine-learning module to determine a price prediction for a product based on a sub-component analysis. Embodiments of the present invention employ multiple techniques in the rule-based module to arrive at a similarity weightage, including image comparison, metadata comparisons, review/rating comparisons, video comparisons. Embodiments of the present invention collect feedback for further pricing optimization by augmenting a Reinforcement Learning (RL) module on top of the ensemble model.

Implementation of embodiments of the invention may take a variety of forms, and exemplary implementation details are discussed subsequently with reference to the Figures.

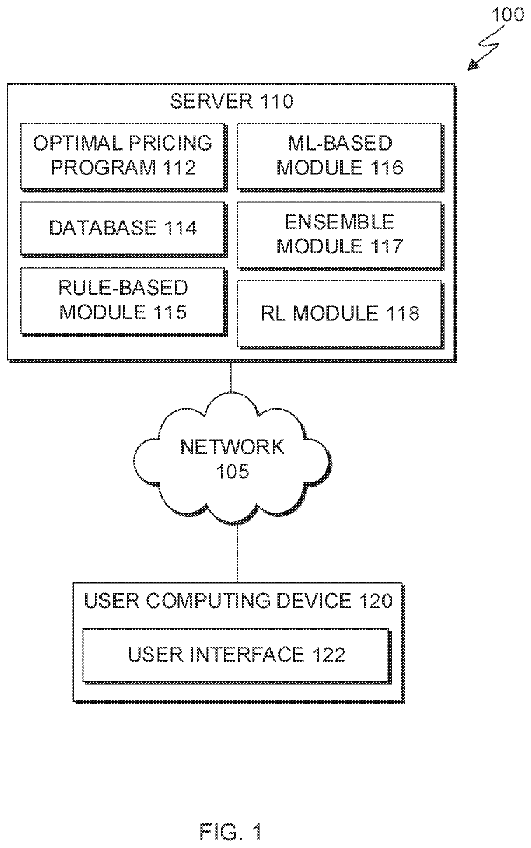

FIG. 1 is a functional block diagram illustrating a distributed data processing environment, generally designated 100, in accordance with one embodiment of the present invention. The term “distributed,” as used herein, describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 110 and user computing device 120, interconnected over network 105. Network 105 can be, for example, a telecommunications network, a local area network (LAN), a wide area network (WAN), such as the Internet, or a combination of the three, and can include wired, wireless, or fiber optic connections. Network 105 can include one or more wired and/or wireless networks capable of receiving and transmitting data, voice, and/or video signals, including multimedia signals that include voice, data, and video information. In general, network 105 can be any combination of connections and protocols that will support communications between server 110, user computing device 120, and other computing devices (not shown) within distributed data processing environment 100.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any programmable electronic device capable of communicating with user computing device 120, and other computing devices (not shown) within distributed data processing environment 100 via network 105. In another embodiment, server 110 represents a computing system utilizing clustered computers and components (e.g., database server computers, application server computers, etc.) that act as a single pool of seamless resources when accessed within distributed data processing environment 100. Server 110 includes optimal pricing program 112, database 114, rule-based module 115, machine-learning module 116, ensemble module 117, and RL module 118. Server 110 may include internal and external hardware components, as depicted and described in further detail with respect to FIG. 5.

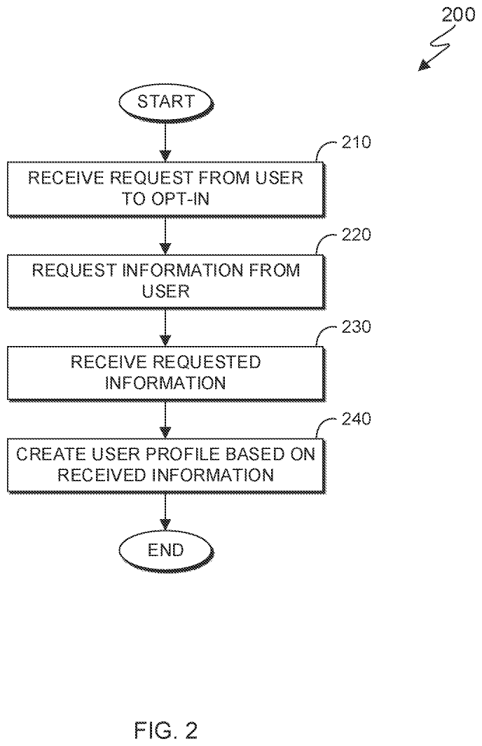

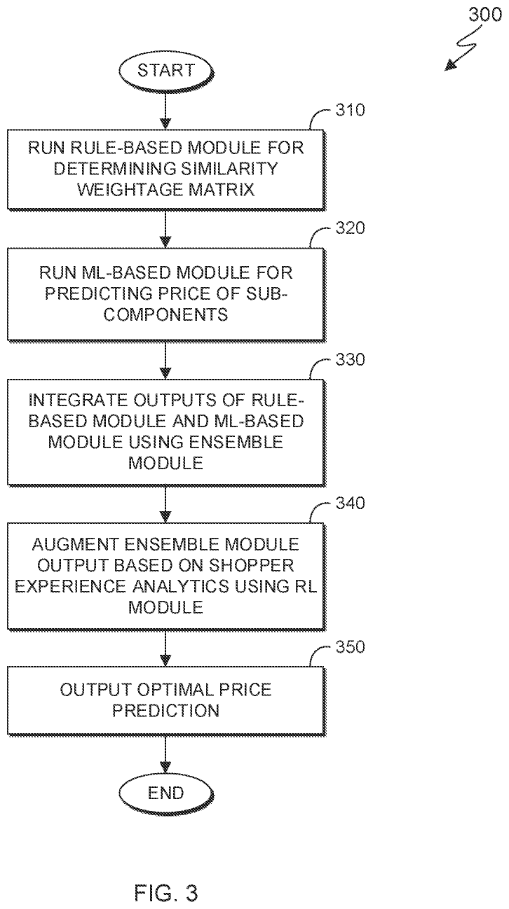

Optimal pricing program 112 operates to perform an optimal pricing prediction for a product based on visual and textual correlation between the product and similar products to determine a similarity weightage and analysis of sub-components of the product. In an embodiment, optimal pricing program 112 utilizes rule-based module 115, machine-learning (ML) based module 116, ensemble module 117, and RL module 118 to perform the optimal pricing prediction. In the depicted embodiment, optimal pricing program 112 is a standalone program. In another embodiment, optimal pricing program 112 may be integrated into another software product, such as a retail pricing software package. In an embodiment, users opt-in to the use of optimal pricing program 112 and set up a user profile with optimal pricing program 112. The setup component of optimal pricing program 112 is depicted and described in further detail with respect to FIG. 2. The main function of optimal pricing program 112, performing an optimal pricing prediction for a product, is depicted and described in further detail with respect to FIG. 3.

It is to be understood that the use of the words “optimal” and “optimized” in a proper name and elsewhere herein refers to an ability to cause an improvement in price prediction, which may not be absolutely optimal in all interpretations or embodiments, since there is often a tradeoff for a given improvement. For example, one parameter of price prediction is optimized while another parameter is exacerbated. As such the names “optimal pricing program 112” is in reference to programs or program elements that have the ability to cause an improvement in at least one aspect of price prediction. Also, the term “optimal price prediction” and “optimized price prediction” is in reference to an output price prediction that is an improvement in at least one aspect to a previous price prediction.

Rule-based module 115 operates to determine a similarity weightage matrix for the product based on specifications of similar products and ratings/reviews for the similar products. Rule-based module 115 determines a similarity weightage for each similar product to the product. Rule-based module 115 utilizes standardized rules to directly compare product features from a specification for a similar product to features of the product. Rule-based module 115 utilizes standardized rules to directly compare ratings (in aggregated form) for a similar product to the product. For example, if the product is a laptop of brand A with processor B and speakers C, rule-based module 115 determines a similarity weightage for a laptop of brand A with processor B but speakers D to be 0.8, showing that the products are 80% similar but should not be priced exactly the same. Rule-based module 115 uses a similarity weightage determined for each similar product to apply that similarity weightage to the price for each similar product, in which the weighted prices for the similar products can be used later by ensemble module 117 to determine an optimized price prediction for the product.

ML-based module 116 operates to produce a price prediction for a product based on a sub-component analysis. ML-based module 116 ingests details of the product through visual and textual data scraped from information online to determine sub-components of the product. ML-based module 116 determines a price prediction for each sub-component of the product and sums up each price prediction for each sub-component to calculate the price prediction for the product.

Ensemble module 117 operates to integrate the similarity weightage matrix from rule-based module 115 and the price prediction from ML-based module 116 to produce an optimized price prediction for the product. Ensemble module 117 operates as an ensemble model using techniques known to a person of skill in the art to use the outputs from rule-based module 115 and ML-based module 116 as features to produce an optimized price prediction for the product. Ensemble module 117 provides the optimized price prediction as classifier information to RL module 118 to further optimize the price prediction for the product.

RL module 118 operates to further optimize the price prediction for the product using feedback from potential purchasers and RL techniques as known to a person of skill in the art. RL module 118 re-tweaks the final predicted pricing of the product dynamically based on shopper experience analytics at the optimized predicted price, e.g., rejections of an offer for the product when a shopper views the product but does not buy it or a rejection of a discount on the product by a shopper. RL module 118 further optimizes the final pricing of the product within a profitable threshold for the retailer (i.e., seller of the product), leading to maximized seller satisfaction.

Database 114 operates as a repository for data received, used, and/or output by optimal pricing program 112. Data received, used, and/or generated may include, but is not limited to, a plurality of user profiles with user profile information input by a user during the setup component described in FIG. 2; and any other data received, used, and/or output by optimal pricing program 112. Database 114 can be implemented with any type of storage device capable of storing data and configuration files that can be accessed and utilized by server 110, such as a hard disk drive, a database server, or a flash memory. In an embodiment, database 114 is accessed by optimal pricing program 112 to store and/or to access the data. In the depicted embodiment, database 114 resides on server 110. In another embodiment, database 114 may reside on another computing device, server, cloud server, or spread across multiple devices elsewhere (not shown) within distributed data processing environment 100, provided that optimal pricing program 112 has access to database 114.

The present invention may contain various accessible data sources, such as database 114, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Optimal pricing program 112 enables the authorized and secure processing of personal data.

Optimal pricing program 112 provides informed consent, with notice of the collection of personal and/or confidential company data, allowing the user to opt in or opt out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Optimal pricing program 112 provides information regarding personal and/or confidential company data and the nature (e.g., type, scope, purpose, duration, etc.) of the processing. Optimal pricing program 112 provides the user with copies of stored personal and/or confidential company data. Optimal pricing program 112 allows the correction or completion of incorrect or incomplete personal and/or confidential company data. Optimal pricing program 112 allows for the immediate deletion of personal and/or confidential company data.

User computing device 120 operates as a computing device associated with a user (e.g., retailer/seller) on which the user can input and/or receive information to/from optimal pricing program 112 and can opt-in to optimal pricing program 112 through an application user interface. In the depicted embodiment, user computing device 120 includes an instance of user interface 122. In an embodiment, user computing device 120 can be a laptop computer, a tablet computer, a smart phone, a smart watch, an e-reader, smart glasses, wearable computer, or any programmable electronic device capable of communicating with various components and devices within distributed data processing environment 100, via network 105. In general, user computing device 120 represents one or more programmable electronic devices or combination of programmable electronic devices capable of executing machine readable program instructions and communicating with other computing devices (not shown) within distributed data processing environment 100 via a network, such as network 105. User computing device 120 may include internal and external hardware components, as depicted and described in further detail with respect to FIG. 5.

User interface 122 provides an interface between optimal pricing program 112 on server 110 and a user of user computing device 120. In one embodiment, user interface 122 is a mobile application software. Mobile application software, or an “app,” is a computer program designed to run on smart phones, tablet computers, and other mobile computing devices. In one embodiment, user interface 122 may be a graphical user interface (GUI) or a web user interface (WUI) that can display text, documents, web browser windows, user options, application interfaces, and instructions for operation, and include the information (such as graphic, text, and sound) that a program presents to a user and the control sequences the user employs to control the program. User interface 122 enables a user of user computing device 120 to create a user profile for optimal pricing program 112, in which the user can input a list of products and any related product information. Further, user interface 122 enables a user of user computing device 120 to opt-in or opt-out of optimal pricing program 112.

FIG. 2 is a flowchart 200 depicting operational steps of a setup component of optimal pricing program 112, on server 110 within distributed data processing environment 100 of FIG. 1, in accordance with an embodiment of the present invention. In an embodiment, optimal pricing program 112 completes a one-time setup with a user to create a user profile with optimal pricing program 112 for the user. The one-time setup allows optimal pricing program 112 to establish a user profile with information from which optimal pricing program 112 can perform optimal pricing predictions as described in more detail with respect to FIG. 3. It should be appreciated that the process depicted in FIG. 2 illustrates one possible iteration of optimal pricing program 112, which may be repeated for each opt-in request received by optimal pricing program 112.

In step 210, optimal pricing program 112 receives a request from a user to opt-in. In an embodiment, optimal pricing program 112 receives a request from a user to opt-into optimal pricing program 112. For example, a retailer, who has just downloaded a retail pricing software, can opt-in to optimal pricing program 112 by checking an opt-in box through a user interface, e.g., user interface 122 on user computing device 120.

In step 220, optimal pricing program 112 requests information from the user. In an embodiment, responsive to optimal pricing program 112 receiving the request from the user to opt-in, optimal pricing program 112 requests information from the user. In an embodiment, optimal pricing program 112 requests, from the user, a list of products the user is selling and any associated information about each product in the list of products. For example, optimal pricing program 112 prompts the user to input a product catalog. In an embodiment, optimal pricing program 112 requests from the user whether they want optimal pricing program 112 to run in a “push” mode or in a “pull” mode. In the “push” mode, optimal pricing program 112, as depicted in FIG. 3, runs iteratively to determine optimal pricing predictions for the user's products and pushes an optimal price prediction to the user through a user interface. For the “push” mode, the user may set a time interval for how often to run optimal pricing program 112 for each product the user input in the user profile, e.g., user sets optimal pricing program to run daily to update an optimal price prediction. In the “pull” mode, the main function of optimal pricing program 112, as depicted and described in FIG. 3, is initiated upon receiving a query from the user asking for an optimal pricing prediction for a certain product.

In step 230, optimal pricing program 112 receives the requested information from the user. In an embodiment, optimal pricing program 112 receives the requested information from the user through a user interface of a user computing device. In an embodiment, responsive to optimal pricing program 112 requesting information from the user, optimal pricing program 112 receives the requested information from the user.

In step 240, optimal pricing program 112 creates a user profile based on the received information. In an embodiment, optimal pricing program 112 creates a user profile for the user and includes the received information. In an embodiment, optimal pricing program 112 stores the user profile and/or the received information in a database, e.g., database 114. In an embodiment, responsive to optimal pricing program 112 receiving the requested information from the user, optimal pricing program 112 creates the user profile based on the received information.

FIG. 3 is a flowchart 300 depicting operational steps of optimal pricing program 112, for performing an optimal pricing prediction for a product based on visual and textual correlation and comparison of sub-components between the product and similar products, in accordance with an embodiment of the present invention. It should be appreciated that the process depicted in FIG. 3 illustrates one possible iteration of optimal pricing program 112, which runs either in a “push” mode or “pull” mode as designated by the user during the setup component.

In step 310, optimal pricing program 112 runs a rule-based module. In an embodiment, optimal pricing program 112 runs rule-based module 115 to determine a similarity weightage matrix for a product based on specifications of similar products and ratings/reviews for the similar products. Rule-based module 115 determines a similarity weightage for each similar product to the product. Rule-based module 115 utilizes standardized rules to directly compare product features from a specification for a similar product to features of the product. Rule-based module 115 utilizes standardized rules to directly compare ratings (in aggregated form) for a similar product to the product. Rule-based module 115 uses a similarity weightage determined for each similar product to apply that similarity weightage to the price for each similar product, in which the weighted prices for the similar products can be used later by ensemble module 117 to determine an optimized price prediction for the product.

In an embodiment in which the user designated the “pull” mode in the user profile, responsive to the user requesting an optimal pricing prediction for a product, optimal pricing program 112 runs the rule-based module for the product. In an embodiment in which the user designated the “push” mode in the user profile, optimal pricing program 112 iteratively runs the rule-based module for each product listed in a user profile as updated information is provided and/or received on products in the user profile of the user.

In step 320, optimal pricing program 112 runs a ML-based module. In an embodiment, optimal pricing program 112 runs ML-based module 116 for making a price prediction of a product based on predicting prices of sub-components of the product. Based on the price predictions for each sub-component, ML-based module 116 outputs an overall price prediction for the product. ML-based module 116 using an ML algorithm that lists down the sub-components of the product, and components of the sub-components, and so on, recursively. In the ML algorithm, until the function reaches the root node, price prediction gathering for each component occurs and then is aggregated to build up the predicted price for the parent node until it reaches the root. Exemplary pseudo-code for the ML algorithm used by ML-based module 116 is presented below:

Function float predictPrice(product):

List all_sub_components = product.getAllSubComponents
For component in all_sub_components:
Predicted_price =+ component.getPredictedPrice
Return predicted_price

Function List getAllSubComponents(product):

```
If product.has_components == false:
  List.add(product)
Else:
  For childComponent in product.getChildComponents:
    List.add(getAllSubComponents(childComponent))
Return list.
```

For each sub-component of the product, the ML algorithm of ML-based module 116 utilizes a price prediction algorithm based on several factors: (1) a base price of the sub-component, (2) a price for work/labor required to integrate the sub-component into the product, and (3) intellectual property (IP) and licensing costs involved with the sub-component. For example, if a laptop is the product and one of the sub-components of the laptop is speaker X, the ML algorithm predicts a price of speaker X as a function of the base price of speaker X, cost to integrate speaker X into the laptop including labor costs, and licensing costs involving with using speaker X, e.g., speaker X brand requires use of its logo and therefore usage of speaker X in the laptop includes price for licensing the logo. Exemplary pseudo-code for the price prediction algorithm is presented below.

Pred_Price(Product) = Pred_Price(Product.Sub_Components) +
Pred_Price(Work required to integrate Product.Sub_Components) +
Pred_Price(Licensing/IP involved in
Product/Product.Sub_Components).

For the first factor of the price prediction algorithm used in ML-based module 116, the price prediction determination for the base price of the sub-component is based on visual data and textual data for the sub-component. For the visual data, the price prediction determination involves comparing images using You Only Look Once (YOLO) version 3 object detection model trained with e-commerce component images and aggregating similar images into a cluster with respective pricing as metadata associated with the components extracted from crowdsourced websites. For the textual data, the price prediction determination uses Named Entity Recognition (NER) text analytics using linear discriminant analysis (LDA) for topic modeling and classification.

For the second factor of the price prediction algorithm used in ML-based module 116, the price prediction determination for the price for work/labor required to integrate the sub-component into the product is a function of clustering the relevant domain/levels based on types of entities, i.e., clustering to standardize in order to understand relative average prices of similar products in the market, and a country in which the labor costs are incurred, i.e., taking into account labor laws of the country in which the product is being built. For example, clustering of domains could have running shoes as one domain, shoes as another domain and/or higher level that running shoes, and clothing as another domain and/or higher level than shoes.

For the third factor of the price prediction algorithm used in ML-based module 116, the price prediction determination for the IP and licensing costs uses NER combined with web scraping to identify entities involved in the product, domain identification and feature scraping, and clustering of relevant domains/levels based on types of entities for other similar products. In other words, clustering to standardize in order to understand relative average prices of similar products in the market. For example, clustering of domains could have running shoes as one domain, shoes as another domain and/or higher level that running shoes, and clothing as another domain and/or higher level than shoes.

In some embodiments, optimal pricing program 112 runs the rule-based module and the ML-based module simultaneously in parallel. In these embodiments, when the user designated the “pull” mode in the user profile, responsive to the user requesting an optimal pricing prediction for a product, optimal pricing program 112 simultaneously runs the rule-based module and the ML-based module. In these embodiments, when the user designated the “push” mode in the user profile, optimal pricing program 112 runs the rule-based module and the ML-based module iteratively as often as set by the user in the user profile.

In step 330, optimal pricing program 112 integrates outputs of the rule-based module and the ML-based module using an ensemble module. In an embodiment, optimal pricing program 112 integrates the similarity weightage matrix output by rule-based module 115 with the price prediction output by ML-based module 116 using ensemble module 117. In step 330, optimal pricing program 112 employs ensemble module 117 to produce an optimized price prediction for the product by using the outputs from rule-based module 115 and ML-based module 116 as input features into an ensemble model. In an embodiment, responsive to receiving an output from the rule-based module and an output from the ML-based module, optimal pricing program 112 integrates the outputs of the rule-based module and the ML-based module using an ensemble module.

In step 340, optimal pricing program 112 augments output of the ensemble module based on shopper experience analytics using an RL module. In an embodiment, responsive to receiving an output from the ensemble module, optimal pricing program 112 augments the output of the ensemble module based on shopper experience analytics using RL module 118. RL module 118 operates to further optimize the price prediction for the product using feedback from potential purchasers and RL techniques as known to a person of skill in the art. RL module 118 re-tweaks the final pricing of the product dynamically based on shopper experience analytics at the predicted price, e.g., rejections of an offer for the product when a shopper views the product but does not buy it. RL module 118 further optimizes the final pricing of the product within a profitable threshold for the retailer (i.e., seller of the product), leading to maximized seller satisfaction.

In step 350, optimal pricing program 112 outputs an optimal price prediction. In an embodiment, responsive to receiving an output from the RL module, optimal pricing program 112 outputs an optimal price prediction. In an embodiment, optimal pricing program 112 outputs the optimal price prediction output by RL module 118. In other embodiments, optimal pricing program 112 does not complete step 340 before outputting an optimal price prediction as output by ensemble module 117. In several embodiments, optimal pricing program 112 outputs the optimal price prediction to a user, e.g., to a retailer through user interface 122 on user computing device 120.

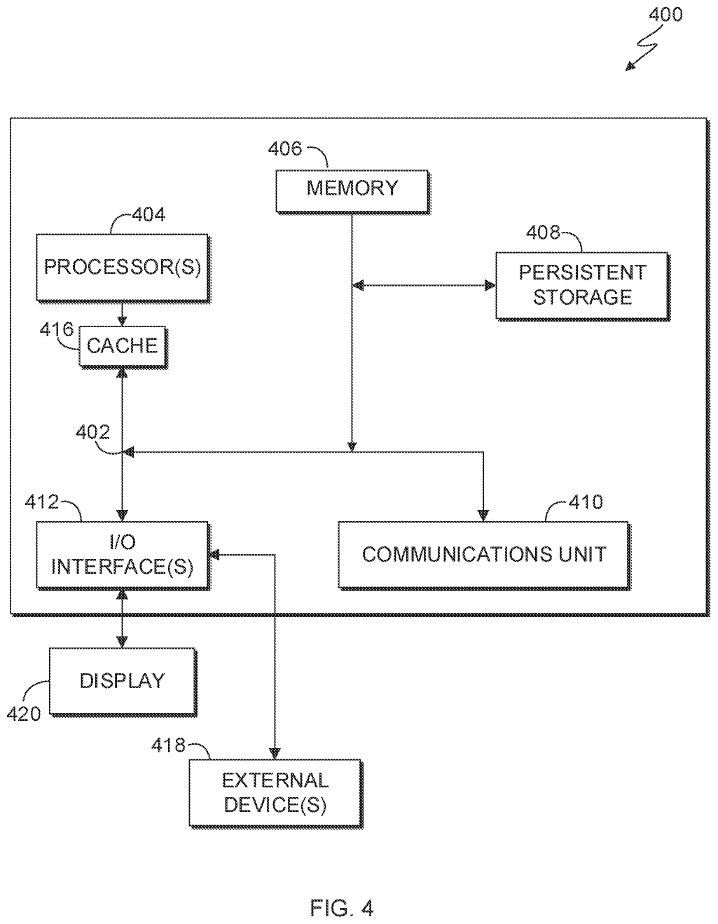

FIG. 4 depicts a block diagram of components of computing device 400, suitable for server 110 and/or user computing device 120 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Computing device 400 includes communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Programs may be stored in persistent storage 408 and in memory 406 for execution and/or access by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Programs may be downloaded to persistent storage 408 through communications unit 410.

I/O interface(s) 412 allows for input and output of data with other devices that may be connected to server 110 and/or user computing device 120. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
determining, by one or more processors, a similarity weightage for each similar product to a product based on specifications and ratings for each similar product;
determining, by the one or more processors, a price for each subcomponent of the product based on a base price of the respective subcomponent, a cost for work required to integrate the respective subcomponent into the product, and intellectual property and licensing costs associated with the respective subcomponent;
calculating, by the one or more processors, a price prediction for the product by summing up the price for each subcomponent; and
determining, by the one or more processors, an optimized price prediction for the product based on integrating the similarity weightage for each similar product with the price prediction for the product in an ensemble model.

2. The computer-implemented method of claim 1, further comprising:
dynamically determining, by the one or more processors, an optimal price prediction for the product by augmenting the optimized price prediction for the product with shopper experience analytics in a reinforcement learning model.

3. The computer-implemented method of claim 1, wherein determining the similarity weightage for each similar product to the product comprises:
responsive to a user through a user device requesting the optimal price prediction for the product, determining, by the one or more processors, the similarity weightage for each similar product to the product based on the specifications and the ratings for each similar product.

4. The computer-implemented method of claim 1, wherein determining the similarity weightage for each similar product to the product further comprises:
comparing, by the one or more processors, product features from the specifications and the ratings for each similar product to the product.

5. The computer-implemented method of claim 1, further comprising:
receiving, by the one or more processors, a list of products from a user through a user device, wherein the product is in the list of products.

6. The computer-implemented method of claim 5, further comprising:
outputting, by the one or more processors, the optimal price prediction for the product to the user device.

7. The computer-implemented method of claim 2, wherein the shopper experience analytics include rejections of an offer for the product by a shopper at the optimized price prediction.

8. A computer program product comprising:
one or more computer readable storage media and program instructions collectively stored on the one or more computer readable storage media, the stored program instructions comprising:
program instructions to determine a similarity weightage for each similar product to a product based on specifications and ratings for each similar product;
program instructions to determine a price for each subcomponent of the product based on a base price of the respective subcomponent, a cost for work required to integrate the respective subcomponent into the product, and intellectual property and licensing costs associated with the respective subcomponent;
program instructions to calculate a price prediction for the product by summing up the price for each subcomponent; and
program instructions to determine an optimized price prediction for the product based on integrating the similarity weightage for each similar product with the price prediction for the product in an ensemble model.

9. The computer program product of claim 8, further comprising:
program instructions to dynamically determine an optimal price prediction for the product by augmenting the optimized price prediction for the product with shopper experience analytics in a reinforcement learning model.

10. The computer program product of claim 8, wherein the program instructions to determine the similarity weightage for each similar product to the product comprise:
responsive to a user through a user device requesting the optimal price prediction for the product, program instructions to determine the similarity weightage for each similar product to the product based on the specifications and the ratings for each similar product.

11. The computer program product of claim 8, wherein the program instructions to determine the similarity weightage for each similar product to the product further comprise:
program instructions to compare product features from the specifications and the ratings for each similar product to the product.

12. The computer program product of claim 8, further comprising:
program instructions to receive a list of products from a user through a user device, wherein the product is in the list of products.

13. The computer program product of claim 12, further comprising:
program instructions to output the optimal price prediction for the product to the user device.

14. The computer program product of claim 9, wherein the shopper experience analytics include rejections of an offer for the product by a shopper at the optimized price prediction.

15. A computer system comprising:
one or more computer processors;
one or more computer readable storage media;
program instructions collectively stored on the one or more computer readable storage media for execution by at least one of the one or more computer processors, the stored program instructions comprising:
program instructions to determine a similarity weightage for each similar product to a product based on specifications and ratings for each similar product;
program instructions to determine a price for each subcomponent of the product based on a base price of the respective subcomponent, a cost for work required to integrate the respective subcomponent into the product, and intellectual property and licensing costs associated with the respective subcomponent;
program instructions to calculate a price prediction for the product by summing up the price for each subcomponent; and
program instructions to determine an optimized price prediction for the product based on integrating the similarity weightage for each similar product with the price prediction for the product in an ensemble model.

16. The computer system of claim 15, further comprising:
program instructions to dynamically determine an optimal price prediction for the product by augmenting the optimized price prediction for the product with shopper experience analytics in a reinforcement learning model.

17. The computer system of claim 15, wherein the program instructions to determine the similarity weightage for each similar product to the product comprise:
responsive to a user through a user device requesting the optimal price prediction for the product, program instructions to determine the similarity weightage for each similar product to the product based on the specifications and the ratings for each similar product.

18. The computer system of claim 15, wherein the program instructions to determine the similarity weightage for each similar product to the product further comprise:
program instructions to compare product features from the specifications and the ratings for each similar product to the product.

19. The computer system of claim 15, further comprising:
program instructions to receive a list of products from a user through a user device, wherein the product is in the list of products.

20. The computer system of claim 19, further comprising:
program instructions to output the optimal price prediction for the product to the user device.
